(19) United States
(12) Patent Application Publication
(10) Pub. No.: US 2025/0078196 A1
(43) Pub. Date: Mar. 6, 2025

(54) DYNAMIC SWITCHING OF FIELDS BASED ON HEAD POSE

(71) Applicant: QUALCOMM Incorporated, San Diego, CA (US)

(72) Inventors: Olk IDAPALAPATI, Hyderabad (IN); Mayukh ROY, Kolkata (IN); Hitesh Venkata RACHAKONDA, Hyderabad (IN)

(21) Appl. No.: 18/461,196

(22) Filed: Sep. 5, 2023

(51) Int. Cl. G06T 1/20; G06F 3/01

(52) U.S. Cl. CPC G06T 1/20; G06F 3/012

(57) ABSTRACT

This disclosure provides systems, devices, apparatus, and methods, including computer programs encoded on storage media, for dynamic field switching based on a head pose. A processor computes a difference between a first pose corresponding to a rendering time instance for a frame and a second pose corresponding to a display time instance for the frame that occurs after the rendering time instance. The processor renders a first set of color fields or a second set of color fields for the frame based on the computed difference and a threshold, where the first set of color fields and the second set of color fields include a first number of color fields and a second number of color fields, respectively, where the first number is less than the second number. The processor outputs an indication of the rendered first set of color fields or the rendered second set of color fields.

### TECHNICAL FIELD

The present disclosure relates generally to processing systems, and more particularly, to one or more techniques for graphics and/or display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for extended reality (XR) content may refresh each color field associated with a frame regardless of a change in head pose of a user and regardless of whether the XR content is static. There is a need for improved techniques for processing XR content.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for graphics processing are provided. The apparatus includes a memory; and a processor coupled to the memory and, based on information stored in the memory, the processor is configured to: compute a difference between (1) a first pose corresponding to a rendering time instance for a frame and a (2) a second pose corresponding to a display time instance for the frame that occurs after the rendering time instance; render a first set of color fields or a second set of color fields for the frame based on the computed difference and a threshold, where the first set of color fields and the second set of color fields include a first number of color fields and a second number of color fields, respectively, where the first number of color fields is less than the second number of color fields; and output an indication of the rendered first set of color fields or the rendered second set of color fields.

In an aspect of the disclosure, a method, a computer-readable medium, and an apparatus for display processing are provided. The apparatus includes a memory; and a processor coupled to the memory and, based on information stored in the memory, the processor is configured to: obtain a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation; read, from the cache and based on the first indication, (1) the set of color fields corresponding to the frame with the invalidate operation or (2) the first subset of the set of color fields with the invalidate operation and the second subset of the set of color fields without the invalidate operation; and output a second indication of (1) the read set of color fields corresponding to the frame with the invalidate operation or (2) the read first subset with the invalidate operation and the read second subset without the invalidate operation.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example display framework including a display processor and a display in accordance with one or more techniques of this disclosure.

FIG. 4 is a diagram illustrating an example process for dynamic switching of color fields based on a head pose in accordance with one or more techniques of this disclosure.

FIG. 5 is a diagram illustrating a first example of a system cache usage for a display pipeline using five color fields for non-static content in accordance with one or more techniques of this disclosure.

FIG. 6 is a diagram illustrating a second example of a system cache usage for a display pipeline using five color fields for static content in accordance with one or more techniques of this disclosure.

FIG. 7 is a call flow diagram illustrating example communications between a graphics processor and a display processing unit (DPU) in accordance with one or more techniques of this disclosure.

FIG. 8 is a flowchart of an example method of graphics processing in accordance with one or more techniques of this disclosure.

FIG. 9 is a flowchart of an example method of graphics processing in accordance with one or more techniques of this disclosure.

FIG. 10 is a flowchart of an example method of display processing in accordance with one or more techniques of this disclosure.

FIG. 11 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

A user may wear a display device in order to experienced extended reality (XR) content. XR may refer to a technology that blends aspects of a digital experience and the real world. An XR device may refer to a device that is capable of presenting XR content to a user. XR may include augmented reality (AR), mixed reality (MR), and/or virtual reality (VR). In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. In MR. MR objects may be superimposed on a real-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. The HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. In VR, a user may experience a fully-immersive digital environment in which the real-world is blocked out. VR content may be experienced through an HMD.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

A split XR system may include an XR device worn by a user (e.g., XR glasses, an HMD, etc.) and a companion device (e.g., a desktop computing device, a server, a phone, etc.), where some processing tasks may be offloaded to the companion device in order to take advantage of processing capabilities of the companion device and/or in order to reduce battery consumption of the XR device. A graphics processor (e.g., a graphics processing unit (GPU)) of the companion device may render a frame including pixels, where each pixel may be associated with a red (R) color field, a green (G) color field, and a blue (B) color field. A color field may refer to a value associated with a color of a pixel. The companion device may transmit the frame to the XR device over a wired connection and/or a wireless connection, whereupon the XR device may perform processing on the frame in order to present the frame on a display of the XR device. For instance, for an XR device with a field sequential display, a GPU of the XR device or a reprojection engine associated with the GPU may compute motion vectors based on pose information of the XR device and the GPU of the XR device may render a set of color fields based on the color fields in the frame (i.e., the R color field, the G color field, and the B color field) and the motion vectors. In an example, the GPU of the XR device may render a frame with 5 color fields: a first red (R1) color field, a first green (G1) color field, a blue (B) color field, a second red (R2) color field, and a second green (G2) color field. The GPU may store the rendered frame in a cache. The different instances of color fields (e.g., R1 and R2, G1 and G2, etc.) may help to correct/account for motion undergone by an XR device (e.g., XR glasses, an XR headset, etc.) over a time period (e.g., a time period between rendering and display). For example, in order to display the rendered frame, a display processing unit (DPU) may read each color field of the rendered frame from the cache with an invalidate operation, where the invalidate operation clears the cache after each color field has been read from the cache. The DPU may output each of the read color fields to a display of the XR device, whereupon the read color fields may be presented sequentially on the display in a relatively short time period (e.g., several milliseconds) such that the read color fields appear form a coherent image that the user may perceive.

However, in some cases, a head of a user of the XR device may remain stationary over a time period, and as a result, a head pose (e.g., a 6 degrees of freedom (6DOF) pose) of the user may not change between a render time and a display time. In such a case, the R1 color field and the R2 color field (and the G1 color field and the G2 color field) may be identical or similar to one another, that is, the R1 color field and the R2 color field may include the same value or a similar value due to the XR device being stationary. In such a case, rendering of the R2 color field and the G2 color field by the GPU of the XR device may be computationally inefficient (e.g., as the R1 color field and the R2 color field may include the same value or a similar value) and may increase power usage of the XR device. Furthermore, reading of all 5 color fields from the cache with an invalidate operation by the DPU of the XR device may also be computationally inefficient (e.g., as the R1 color field and the R2 color field may include the same value or a similar value) and may increase power usage of the XR device.

Various technologies pertaining to dynamic switching of color fields based on a head pose are described herein. In an example, an apparatus (e.g., a graphics processor of an XR device) computes a difference between (1) a first pose corresponding to a rendering time instance for a frame and a (2) a second pose corresponding to a display time instance for the frame that occurs after the rendering time instance. The apparatus renders a first set of color fields or a second set of color fields for the frame based on the computed difference and a threshold, where the first set of color fields and the second set of color fields include a first number of color fields and a second number of color fields, respectively, where the first number of color fields is less than the second number of color fields. The apparatus outputs an indication of the rendered first set of color fields or the rendered second set of color fields. Vis-à-vis rendering a first set of color fields (e.g., R1 G1 B) or a second set of color fields (e.g., R1 R2 G1 G2 B) for the frame based on the computed difference and a threshold, where the first set of color fields and the second set of color fields include a first number of color fields and a second number of color fields, respectively, where the first number of color fields is less than the second number of color fields, the apparatus (e.g., a graphics processor) may conserve computing resources and power resources, as the apparatus (e.g., a graphics processor) may render 3 color fields instead of 5 color fields in cases where a pose of the user remains relatively static between a render time and a display time. In another example, an apparatus (e.g., a DPU of the XR device) obtains a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation. The apparatus reads, from the cache and based on the first indication, (1) the set of color fields corresponding to the frame with the invalidate operation or (2) the first subset of the set of color fields with the invalidate operation and the second subset of the set of color fields without the invalidate operation. The apparatus outputs a second indication of (1) the read set of color fields corresponding to the frame with the invalidate operation or (2) the read first subset with the invalidate operation and the read second subset without the invalidate operation. Vis-à-vis reading, from the cache and based on the first indication, (1) the set of color fields (e.g., R1 R2 G1 G2 B) corresponding to the frame with the invalidate operation or (2) the first subset (e.g., R2 G2 B) of the set of color fields with the invalidate operation and the second subset (e.g., R1 G1) of the set of color fields without the invalidate operation, the apparatus (e.g., a DPU) may conserve computing resources and power resources, as the second subset of the color fields may remain in the cache due to the read without invalidate operation.

In one aspect presented herein, in order to save processing resources/power resources in a 5-field sequential display, motion vectors for 3 fields (R1, G1, B) may be updated, written, and generated when there is static content and/or low head movement of a headset. The R2 and G2 content may be read from the same buffer as R1 and G1 and may be invalidated after the reading is done to clean cache lines. If there is above a threshold amount of movement or dynamic content, then all five fields may be updated.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

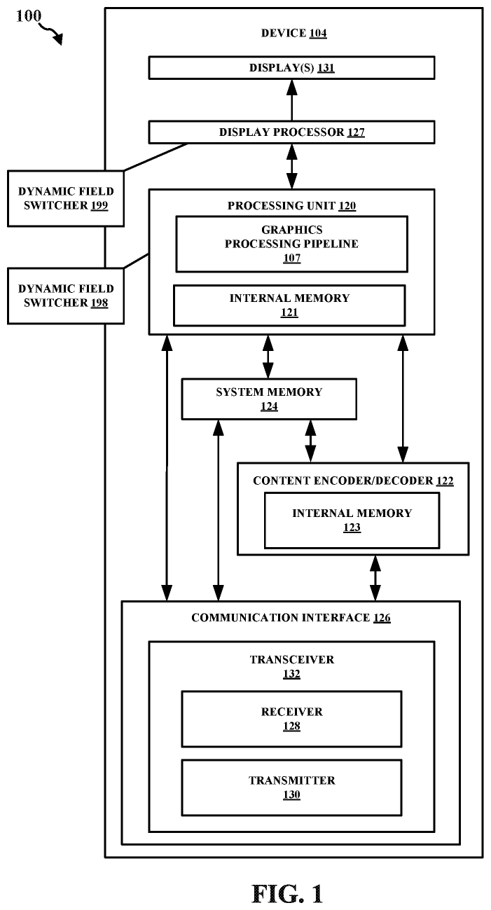

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a dynamic field switcher 198 configured to compute a difference between (1) a first pose corresponding to a rendering time instance for a frame and a (2) a second pose corresponding to a display time instance for the frame that occurs after the rendering time instance; render a first set of color fields or a second set of color fields for the frame based on the computed difference and a threshold, where the first set of color fields and the second set of color fields include a first number of color fields and a second number of color fields, respectively, where the first number of color fields is less than the second number of color fields; and output an indication of the rendered first set of color fields or the rendered second set of color fields. In certain aspects, the display processor 127 may include a dynamic field switcher 199 configured to obtain a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation; read, from the cache and based on the first indication, (1) the set of color fields corresponding to the frame with the invalidate operation or (2) the first subset of the set of color fields with the invalidate operation and the second subset of the set of color fields without the invalidate operation; and output a second indication of (1) the read set of color fields corresponding to the frame with the invalidate operation or (2) the read first subset with the invalidate operation and the read second subset without the invalidate operation. Although the following description may be focused on processing pertaining to XR content, the concepts described herein may be applicable to non-XR content. Furthermore, although the following description may be focused on a device that utilizes a 5 color field format (i.e., a 5 field sequential display), the concepts presented herein may also be applicable to other color field formats as well. In one example, the concepts described herein may be applicable to a 6 color field format (i.e., a 6 field sequential display) that includes R1, G1, B1, R2, G2, and B2 color fields in which R1, G1, and B1 are read without invalidate and in which R2, G2, and B2 are read with invalidate. In another example, the concepts described herein may be applicable to a 4 field color format (i.e., a 4 field sequential display) that includes R1, G, B, and R2 color fields in which R1 is read without invalidate and in which R2, G, and B are read with invalidate. In a further example, the concepts described herein may be applicable to a 5 color field format (i.e., a 5 field sequential display) that includes R1, G, B1, R2, and B2 color fields in which R1 and B1 are read without invalidate and in which R2, G, and B2 are read with invalidate. In yet another example, the concepts described herein may be applicable to a 5 color field format (i.e., a 5 field sequential display) that includes R1, G, B1, R2, and B2 color fields in which G1 and B1 are read without invalidate and in which R, G2, and B2 are read with invalidate. Furthermore, although the concepts described herein utilize an RGB color format, the concepts described herein may also be applicable to other color formats as well, such as a luma chroma (YUV) format.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

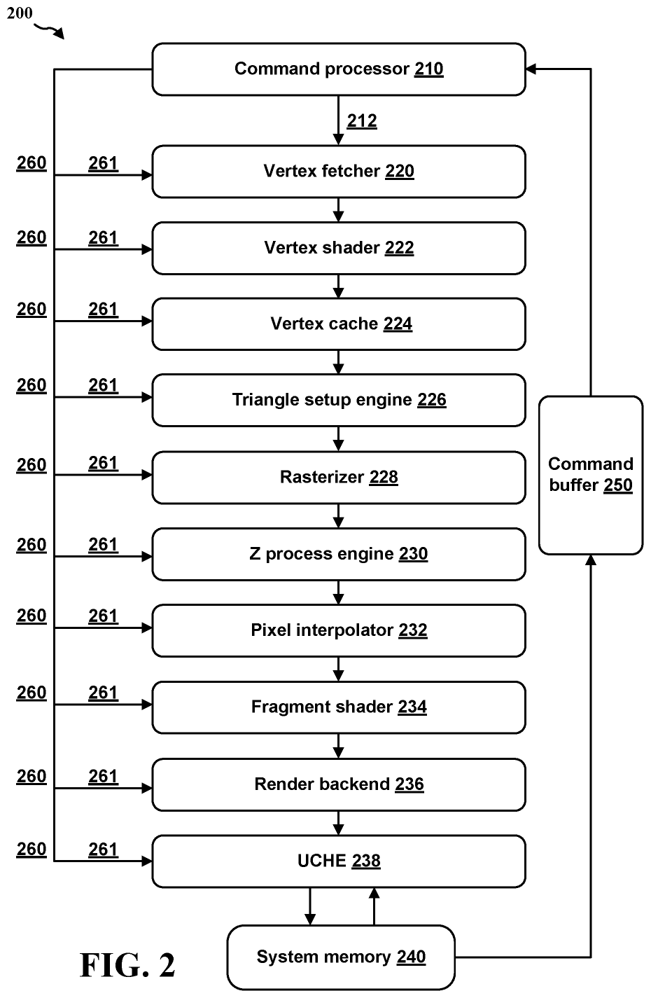

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

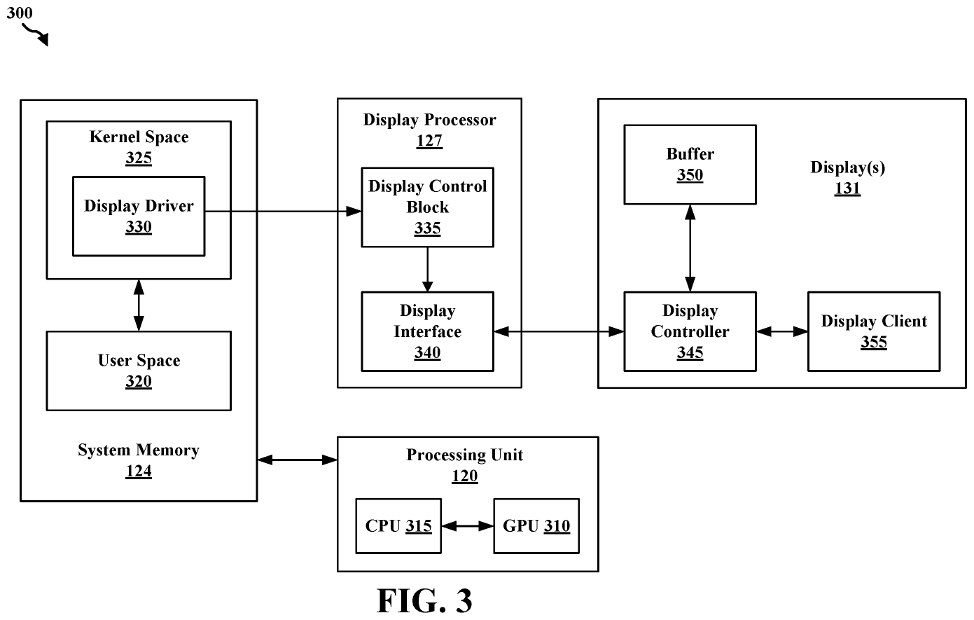

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

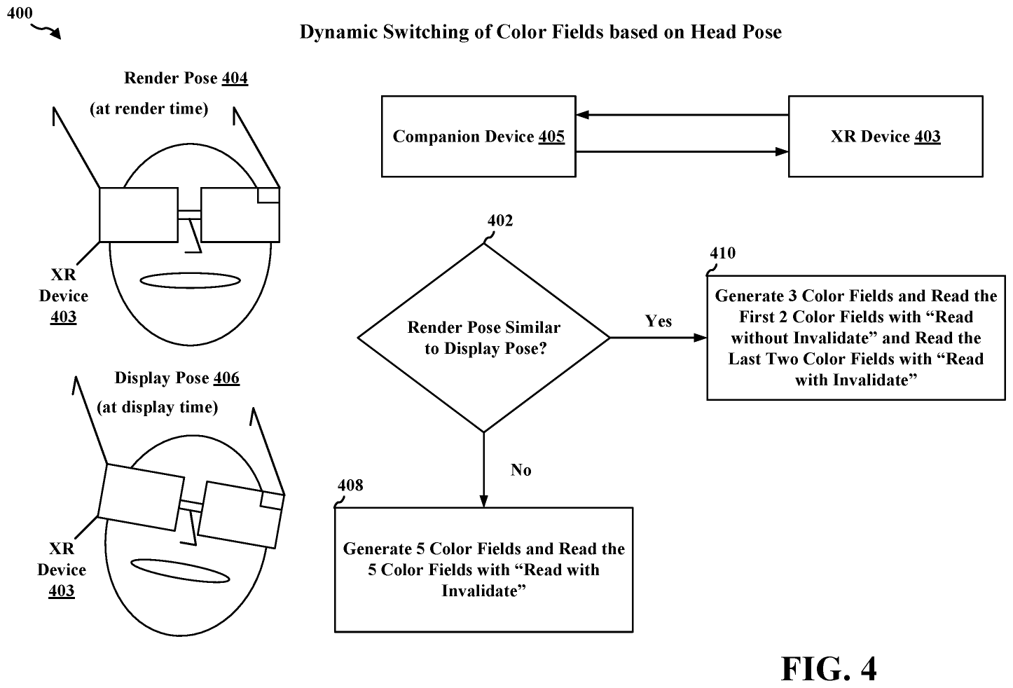

FIG. 4 is a diagram 400 illustrating an example process for dynamic switching of color fields based on a head pose in accordance with one or more techniques of this disclosure. The process may be performed by a device 104 or another device.

Some XR systems may utilize split XR rendering. Split XR rendering may refer to a rendering paradigm whereby a first portion of XR rendering tasks (or other tasks) for XR content are performed by a companion device 405 and a second portion of XR rendering tasks (or other tasks) for the XR content are performed by a XR device 403. The final rendered content may be presented on a display (e.g., a field sequential display, such as a 5 field sequential display) of the XR device. In general, the companion device 405 may possess relatively greater computational capabilities than computational capabilities of the XR device 403. For instance, the companion device 405 may have a greater amount of memory, faster processor(s), etc. in comparison to memory and processor(s) of the XR device 403. In an example, the companion device 405 may be a server, a video game console, a desktop computing device, or a mobile computing device such as a laptop computing device, a tablet computing device, or a smartphone. In an example, the companion device 405 may be or include the device 104. In an example, the XR device 403 may be XR glasses, an HMD, or a smartphone. In an example, the XR device 403 may be or include the device 104. The companion device 405 and the XR device 403 may communicate over a wired connection and/or a wireless connection. In an example, the wired connection may be or include an Ethernet connection and/or a universal serial bus (USB) connection. In an example, the wireless connection may be or include a 5G New Radio (NR) connection, a Bluetooth™ (Bluetooth is a trademark of the Bluetooth Special Interest Group (SIG)) connection, and/or a wireless local area network (WLAN) connection, such as a Wi-Fi™ (Wi-Fi is a trademark of the Wi-Fi Alliance) connection based on the Institute of Electrical and Electronics Engineers (IEEE) 802.11 standard.

The XR device 403 may transmit pose information (as well as other information) to the companion device 405. The other information may include state information (e.g., game state information), input information, a timestamp at which the pose information was generated, etc. The companion device 405 may render a frame that includes a red (R) color field, a green (G) color field, and a blue (B) color field for each pixel of the frame based on the pose information (and/or the other information). The R color field, the G color field, and B color field rendered by the companion device 405 may be referred to herein as a set of generated color fields. Furthermore, as used herein, an R color field may also be referred to as “R,” a G color field may also be referred to as “G,” and a B color field may also be referred to as “G.” The companion device 405 may transmit the frame to the companion device 405 over a wired connection and/or a wireless connection.

At 402, the XR device 403 may determine whether a render pose 404 associated with a frame is similar to a display pose 406 associated with the frame. With more particularity, the render pose 404 may refer to a pose (e.g., a six degrees of freedom (6DOF) pose that includes translation information (e.g., xyz) and rotation information (e.g., roll, pitch, yaw)) of the XR device 403 at a rendering time instance (i.e., a time instance at which the frame is rendered) of the frame. In an example, the render pose 404 may be associated with the pose information transmitted to the companion device 405. The display pose 406 may refer to a pose of the XR device 403 at a display time instance (i.e., a time instance at which the frame is to be displayed), where the display time instance occurs after the rendering time instance. In order to determine whether the render pose 404 is similar to the display pose 406, the XR device 403 may compute a difference between the render pose 404 and the display pose 406 and the XR device 403 may compare the difference to a threshold (e.g., a pose threshold). If the difference is less than or equal to the threshold, the XR device 403 may determine that the render pose 404 is similar to the display pose 406. If the difference is greater than the pose threshold, the XR device 403 may determine that the render pose is not similar to the display pose 406.

In one aspect, the XR device 403 may compute a difference between an x-coordinate of the render pose 404 and an x-coordinate of the display pose 406, a difference between a y-coordinate of the render pose 404 and a y-coordinate of the display pose 406, a difference between a z-coordinate of the render pose 404 and a z-coordinate of the display pose 406, a difference between a roll of the render pose 404 and a roll of the display pose 406, a difference between a pitch of the render pose 404 and a pitch of the display pose 406, and a difference between a yaw of the render pose 404 and a yaw of the display pose 406 (collectively, “the differences”). The XR device 403 may compare each of the differences to a different threshold (e.g., an x-coordinate threshold, a y-coordinate threshold, a z-coordinate threshold, a roll threshold, a pitch threshold, and a yaw threshold (collectively “the thresholds”)). In an example, the XR device 403 may determine that the render pose 404 and the display pose 406 are similar when each of the differences are less than or equal to each of their respective thresholds or the XR device 403 may determine that the render pose 404 and the display pose 406 are not similar when each of the differences are greater than each of their respective thresholds. In another example, the XR device 403 may determine that the render pose 404 and the display pose 406 are similar when a subset of the differences is less than or equal to each of their respective thresholds or the XR device 403 may determine that the render pose 404 and the display pose 406 are not similar when the subset of the differences are greater than each of their respective thresholds.

In another aspect, the XR device 403 may compute a first representative value for the render pose 404 (e.g., based on the translation information and the rotation information of the render pose 404). The XR device 403 may also compute a second representative value for the display pose 406 (e.g., based on the translation information and the rotation information of the display pose 406). The XR device 403 may compute a difference between the first representative value and the second representative value. The XR device 403 may determine that the render pose 404 and the display pose 406 are similar to one another when the difference is less than or equal to a threshold representative value. The XR device 403 may determine that the render pose 404 and the display pose 406 are not similar to one another when the difference is greater than the threshold representative value.

At 408, when the render pose is not similar to the display pose, a GPU of the XR device 403 (or a reprojection engine associated with the GPU) may generate (i.e., render) 5 color fields (R1, R2, G1, G2, and B) based on the R color field, the G color field, and the B color field of the frame rendered by the companion device 405. With more particularity, the GPU of the XR device 403 may generate a set of motion vectors based on the display pose 406. A motion vector may be a motion vector of a color field. A motion vector of a color field may refer to a map (e.g., a set of vectors) that includes information about motion of each pixel of a color field. The GPU of the XR device 403 may generate the 5 color fields based on the set of motion vectors and the R color field, the G color field, and the B color field of the frame received from the companion device 405.

The GPU of the XR device 403 may store (i.e., write to) the generated 5 color fields in a cache of the XR device 403. The GPU of the XR device 403 may also transmit an indication to a DPU of the XR device 403 that indicates that 5 color fields were generated. The DPU of the XR device 403 may read the 5 color fields with a “read with invalidate operation” from the cache based on the indication. A read with invalidate operation may include reading color field(s) (e.g., R1, G1, B, R2, and G2) from the cache while invalidating (i.e., clearing) the cache after reading. After the read with invalidate operation, the color field(s) may not be present in the cache. For instance, in the read with invalidate operation, a DPU of the device may read the 5 color fields from the cache, transmit the 5 color fields (e.g., values in the 5 color fields) to a display of the device, and then clear the 5 color fields from the cache. Each of the 5 color fields may be displayed sequentially over a relatively short time period on a display of the XR device 403 such that a coherent image is formed. As long as subsequent display poses remain dissimilar to subsequent rendering poses, the XR device 403 may repeat the above-described process for subsequent frames. When subsequent display poses are no longer dissimilar to subsequent rendering poses, the XR device 403 may perform aspects described above in connection with 410 below. Aspects pertaining to 408 will be discussed in greater detail below.

At 410, when the render pose is similar to the display pose, the GPU of the XR device 403 (or a reprojection engine associated with the GPU) may generate (i.e., render) 3 color fields (R1, G1, and B) based on the R color field, the G color field, and the B color field of the frame rendered by the companion device 405. With more particularity, the GPU of the XR device 403 may generate a set of motion vectors based on the display pose 406. The GPU of the XR device 403 may generate the 3 color fields based on the set of motion vectors and the R color field, the G color field, and the B color field of the frame received from the companion device 405.

The GPU of the XR device 403 may store (i.e., write) the generated 3 color fields in a cache of the XR device 403. In an example, the cache may include/store an R2 and a G2 color field associated with a prior frame. After the generated 3 color fields are stored in the cache, the cache may include R1, G1, and B (associated with the current frame) and R2 and G2 (associated with the prior frame). The GPU of the XR device 403 may also transmit an indication to the DPU of the XR device 403 that indicates that 3 color fields were generated. Additionally, or alternatively, the indication may indicate that XR content has remained static between the rendering time instance and the display time instance. The DPU of the XR device 403 may read the R1 color field and the G1 color field from the cache with a read without invalidate operation based on the indication. A read without invalidate operation may include reading color field(s) from the cache without subsequently removing the color field(s) from the cache. The DPU of the XR device 403 may read the R2 color field, the G2 color field, and the B color field from the cache with the invalidate operation based on the indication. After the read without invalidate and the read with invalidate operations are performed, the R1 color field and the G1 color field may remain in the cache, while the R2 color field, the G2 color field, and the B color field may be removed from the cache. The DPU of the XR device 403 may transmit the read color fields to a display of the XR device 403 for presentation. Each of the 5 color fields may be displayed sequentially over a relatively short time period on a display of the XR device 403 such that a coherent image is formed. As long as subsequent display poses remain similar to subsequent rendering poses, the XR device 403 may repeat the above-described process for subsequent frames. When subsequent display poses are no longer similar to subsequent rendering poses, the XR device 403 may perform aspects described above in connection with 408. Aspects pertaining to 410 will be discussed in greater detail below.

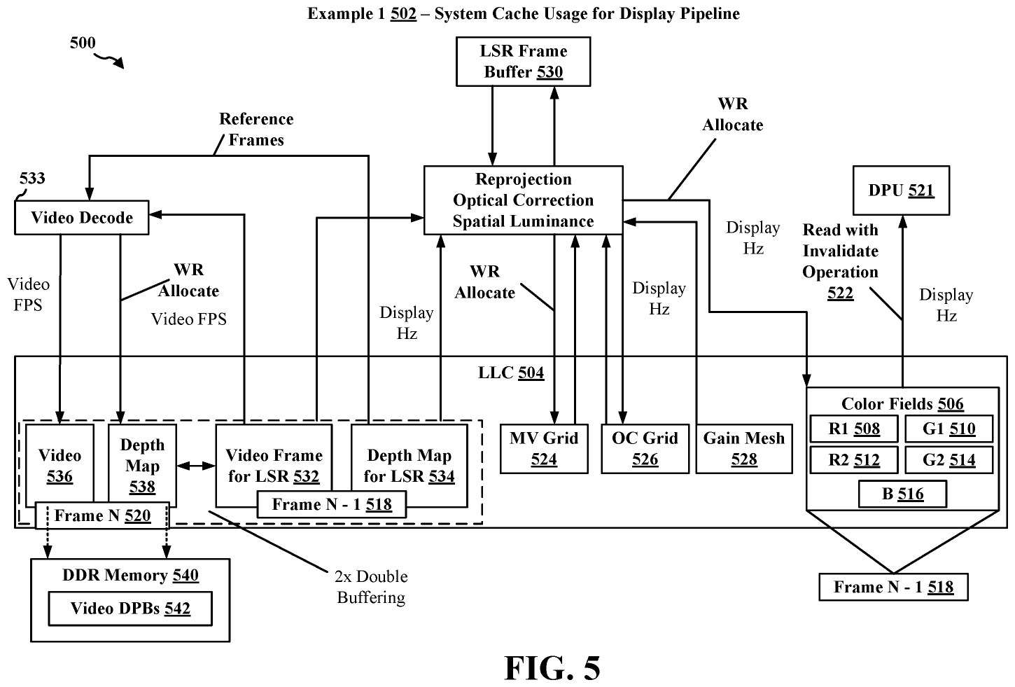

FIG. 5 is a diagram 500 illustrating a first example 502 of a system cache usage for a display pipeline using five color fields for non-static content in accordance with one or more techniques of this disclosure. The first example 502 may correspond to 408 in FIG. 4.

The device 104 (e.g., the XR device 403) may include a last level cache (LLC) 504. As described above with respect to 408 in FIG. 4, a graphics processor (e.g., a GPU, such as the GPU 200) of the device (or a reprojection enginge associated with the graphics processor) may render and store color fields 506 in the LLC 504. The color fields 506 may include R1 508, G1 510, R2 512, G2 514, and B 516. The color fields may be associated with an N−1 frame 518. A DPU 521 of the device 104 may receive an indication from the graphics processor that indicates that the render pose 404 is not similar to the display pose 406. Additionally, or alternatively, the indication may indicate that the graphics processor has rendered 5 color fields (e.g., R1 508, G1 510, R2 512, G2 514, and B 516) and that the 5 color fields have been stored in the LLC 504. Based on the indication, the DPU 521 may read the color fields 506 from the LLC 504 with a read with invalidate operation 522. The DPU 521 may transmit the color fields 506 for presentation on a display (e.g., the display(s) 131). In an example, the color fields 506 may be presented sequentially on the display(s) 131 in order to form a coherent image, which may be referred to as color field based streaming. In another example, the color fields 506 may be blended and presented on the display, which may be referred to as full frame based streaming. After the read with invalidate operation 522, the color fields 506 may be removed from the LLC 504.

Writing to the LLC 504 may be performed via write allocate (WR allocate) operations. The LLC 504 may be associated with reprojection, optical correction, and/or spatial luminance operations. The LLC 504 may be associated with video operations (i.e., “Video FPS”) and display operations (i.e., “Display Hz”). The video operations may include video decoding (i.e., “Video Decode 533”), which may be based on reference frames. The LLC 504 may also include a motion vector (MV) grid 524 which may store motion vectors generated by the graphics processor (or the reprojection engine associated with the graphics processor). The graphics processor may utilize the motion vectors (and a frame received from the companion device 405) to generate the color fields 506. The LLC 504 may include an optical correction (OC) grid 526 that may be used for optical correction. The LLC 504 may include a gain mesh 528 that may be used for the reprojection, optical correction, and/or spatial luminance operations. The LLC 504 may include a late stage reprojection (LSR) frame buffer 530 that may store data used by the DPU 521 to perform an LSR. LSR may refer to adjusting an image based on latest available pose information.

The LLC 504 may include a video frame for LSR 532 and a depth map for LSR 534. where the video frame for LSR 532 and the depth map for LSR 534 may be associated with the N−1 frame 518. The LLC 504 may also include video 536 and a depth map 538 for an N frame 520 that is subsequent to the N−1 frame 518. The N frame 520 and the N−1 frame 518 may be associated with double buffering. The video 536 and the depth map 538 may be transferred to the LLC 504 from DDR memory 540 which is separate from the LLC 504. The DDR memory 540 may store video decoder picture buffers (DPBs) 542.

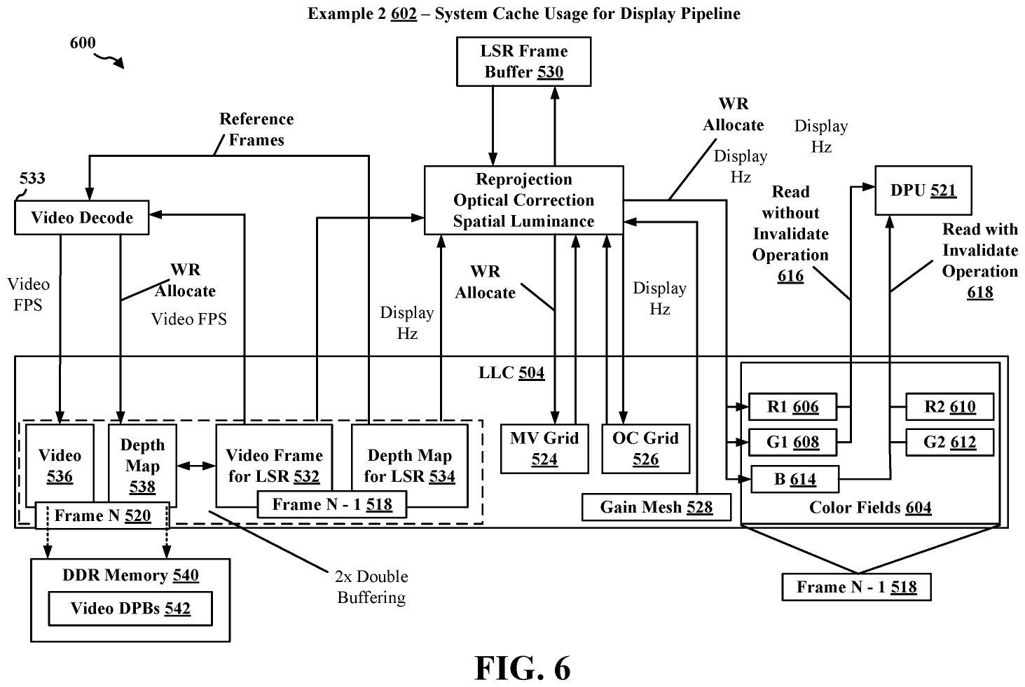

FIG. 6 is a diagram 600 illustrating a second example 602 of a system cache usage for a display pipeline using five color fields for static content in accordance with one or more techniques of this disclosure. The second example 602 may correspond to 410 in FIG. 4.

As described above with respect to 410 in FIG. 4, a graphics processor (e.g., a GPU, such as the GPU 200) of the device (or a reprojection engine associated with the graphics processor) may render and store color fields 604 in the LLC 504. The color fields 604 may include R1 606, G1 608, R2 610, G2 612, and B 614. In an example, R1 606, G1 608, and B 614 may correspond to frame N−1 (i.e., a current frame) and R2 610 and G2 612 may correspond to a prior frame. The DPU 521 of the device 104 may receive an indication from the graphics processor that indicates that the render pose 404 is similar to the display pose 406. Additionally, or alternatively, the indication may indicate that the graphics processor has rendered 3 color fields (e.g., R1 606, G1 608, and B 614) and that the 3 color fields have been stored in the LLC 504. Based on the indication, the DPU 521 may read R1 606 and G1 608 with a read without invalidate operation 616 and the DPU 521 may read R2 610, G2 612, and B 614 with a read with invalidate operation 618. The DPU 521 may transmit the color fields 604 for presentation on a display (e.g., the display(s) 131). In an example, the color fields 604 may be presented sequentially on the display(s) 131 in order to form a coherent image, which may be referred to as color field based streaming. In another example, the color fields 604 be blended and presented on the display, which may be referred to as full frame based streaming. After the read without invalidate operation 616 and the read with invalidate operation 618, R1 606 and G1 608 may remain in the LLC 504, while B 614, R2 610, and G2 612 may be removed from the LLC 504.

The above-described technologies may be associated with various advantages. For example, an XR device (e.g., the XR device 403) may have limited battery capacity, and the above-described technologies may reduce power consumption of the XR device, as the XR device may avoid generating all 5 color fields in cases in which a render pose is similar to a display pose. Furthermore, the above-described technologies may enable dynamic switching between a full workload and an optimized workload without exiting out of a current XR session between an XR device and a companion device, which may also help to conserve power at the XR device. Furthermore, the above-described technologies may also be used to switch between 5 color field rendering and 3 color field rendering at a frame level, which may facilitate a flexible rendering scheme.

In one aspect, an application executed by the device 104 may be aware of static content use cases. In such an aspect, the application may control a mode in which the DPU 521 operates and scheduling may be performed by a reprojection engine associated with a graphics processor.

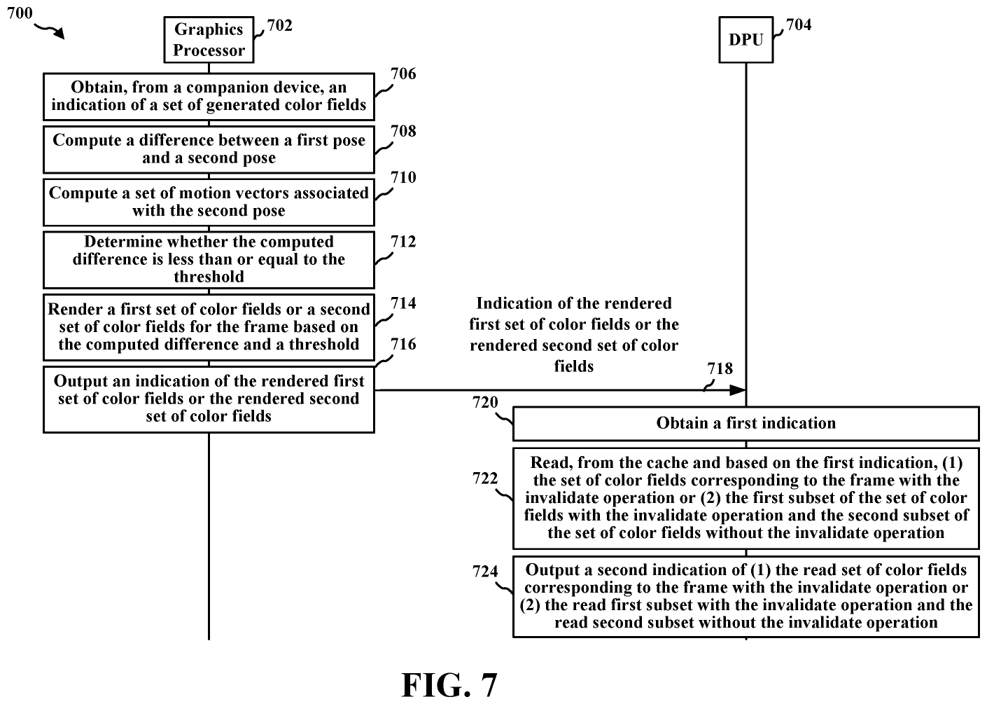

FIG. 7 is a call flow diagram 700 illustrating example communications between a graphics processor 702 (e.g., a GPU, such as the GPU 200) and a DPU 704 in accordance with one or more techniques of this disclosure. In an example, the graphics processor 702 and the DPU 704 (e.g., the display processor 127, the DPU 521) may be included in the device 104.

At 708, the graphics processor 702 may compute a difference between (1) a first pose corresponding to a rendering time instance for a frame and a (2) a second pose corresponding to a display time instance for the frame that occurs after the rendering time instance. At 714, the graphics processor 702 may render a first set of color fields or a second set of color fields for the frame based on the computed difference and a threshold, where the first set of color fields and the second set of color fields may include a first number of color fields and a second number of color fields, respectively, where the first number of color fields may be less than the second number of color fields. At 716, the graphics processor 702 may output an indication of the rendered first set of color fields or the rendered second set of color fields. For instance, at 718, the graphics processor 702 may transmit the indication of the rendered first set of color fields or the rendered second set of color fields to the DPU 704.

In one aspect, at 706, the graphics processor 702 may obtain, from a companion device, a second indication of a set of generated color fields associated with the companion device, where rendering the first set of color fields or the second set of color fields for the frame at 714 may include rendering the first set of color fields or the second set of color fields for the frame further based on the second indication of the set of generated color fields. In one aspect, at 710, the graphics processor 702 may compute a set of motion vectors associated with the second pose, where rendering the first set of color fields or the second set of color fields at 714 may include rendering the first set of color fields or the second set of color fields further based on the set of motion vectors. In one aspect, at 712, the graphics processor 702 may determine whether the computed difference is less than or equal to the threshold, where rendering the first set of color fields or the second set of color fields at 714 may include rendering the first set of color fields or the second set of color fields based on the determination.

At 720, the DPU 704 may obtain a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation. The first indication may correspond to the indication transmitted by the graphics processor 702 at 718. At 722, the DPU 704 may read, from the cache and based on the first indication, (1) the set of color fields corresponding to the frame with the invalidate operation or (2) the first subset of the set of color fields with the invalidate operation and the second subset of the set of color fields without the invalidate operation. At 724, the DPU 704 may output a second indication of (1) the read set of color fields corresponding to the frame with the invalidate operation or (2) the read first subset with the invalidate operation and the read second subset without the invalidate operation.

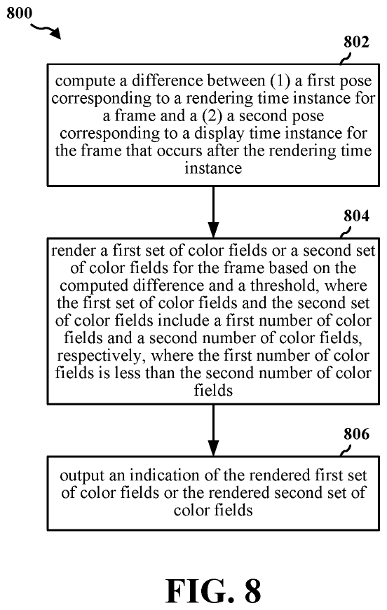

FIG. 8 is a flowchart 800 of an example method of graphics processing in accordance with one or more techniques of this disclosure. The method may be performed by an apparatus, such as an apparatus for graphics processing, a graphics processor (e.g., a GPU, such as the GPU 200), a CPU, the device 104, the XR device 403, a wireless communication device, and the like, as used in connection with the aspects of FIGS. 1-7. In an example, the method may be associated with various advantages at a graphics processor, such as reduced computational burdens and reduced power consumption via dynamic color field switching. In an example, the method may be performed by the dynamic field switcher 198.

At 802, the apparatus (e.g., a graphics processor) computes a difference between (1) a first pose corresponding to a rendering time instance for a frame and a (2) a second pose corresponding to a display time instance for the frame that occurs after the rendering time instance. For example, FIG. 7 at 708 shows that the graphics processor 702 may compute a difference between (1) a first pose corresponding to a rendering time instance for a frame and a (2) a second pose corresponding to a display time instance for the frame that occurs after the rendering time instance. In an example, the first pose may be the render pose 404 and the second pose may be the display pose 406. In an example, the frame may be the N−1 frame 518. In an example, 802 may be performed by the dynamic field switcher 198.

At 804, the apparatus (e.g., a graphics processor) renders a first set of color fields or a second set of color fields for the frame based on the computed difference and a threshold, where the first set of color fields and the second set of color fields include a first number of color fields and a second number of color fields, respectively, where the first number of color fields is less than the second number of color fields. For example, FIG. 7 at 714 shows that the graphics processor 702 may render a first set of color fields or a second set of color fields for the frame based on the computed difference and a threshold, where the first set of color fields and the second set of color fields include a first number of color fields and a second number of color fields, respectively, where the first number of color fields is less than the second number of color fields. In an example, rendering the first set of color fields may correspond to 410 in FIG. 4 and rendering the second set of color fields may correspond to 408 in FIG. 4. In an example, the first set of color fields may include R1 608, G1 608, and B 614. In an example, the second set of color fields may be the color fields 506. In an example, 804 may be performed by the dynamic field switcher 198.

At 806, the apparatus (e.g., a graphics processor) outputs an indication of the rendered first set of color fields or the rendered second set of color fields. For example, FIG. 7 at 716 shows that the graphics processor 702 may output an indication of the rendered first set of color fields or the rendered second set of color fields. In an example, the indication may be output to a DPU (e.g., the DPU 704, the DPU 521, etc.). In an example, 806 may be performed by the dynamic field switcher 198.

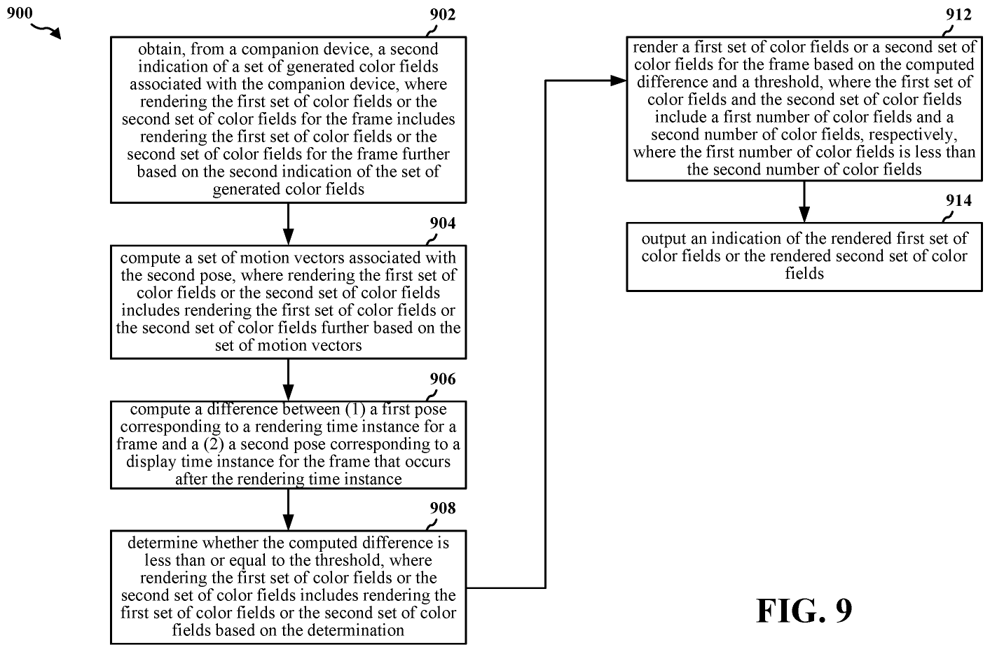

FIG. 9 is a flowchart 900 of an example method of graphics processing in accordance with one or more techniques of this disclosure. The method may be performed by an apparatus, such as an apparatus for graphics processing, a graphics processor (e.g., a GPU, such as the GPU 200), a CPU, the device 104, the XR device 403, a wireless communication device, and the like, as used in connection with the aspects of FIGS. 1-7. In an example, the method may be associated with various advantages at a graphics processor, such as reduced computational burdens and reduced power consumption via dynamic color field switching. In an example, the method (including the various aspects detailed below) may be performed by the dynamic field switcher 198.

At 906, the apparatus (e.g., a graphics processor) computes a difference between (1) a first pose corresponding to a rendering time instance for a frame and a (2) a second pose corresponding to a display time instance for the frame that occurs after the rendering time instance. For example, FIG. 7 at 708 shows that the graphics processor 702 may compute a difference between (1) a first pose corresponding to a rendering time instance for a frame and a (2) a second pose corresponding to a display time instance for the frame that occurs after the rendering time instance. In an example, the first pose may be the render pose 404 and the second pose may be the display pose 406. In an example, the frame may be the N−1 frame 518. In an example, 906 may be performed by the dynamic field switcher 198.

At 912, the apparatus (e.g., a graphics processor) renders a first set of color fields or a second set of color fields for the frame based on the computed difference and a threshold, where the first set of color fields and the second set of color fields include a first number of color fields and a second number of color fields, respectively, where the first number of color fields is less than the second number of color fields. For example, FIG. 7 at 714 shows that the graphics processor 702 may render a first set of color fields or a second set of color fields for the frame based on the computed difference and a threshold, where the first set of color fields and the second set of color fields include a first number of color fields and a second number of color fields, respectively, where the first number of color fields is less than the second number of color fields. In an example, rendering the first set of color fields may correspond to 410 in FIG. 4 and rendering the second set of color fields may correspond to 408 in FIG. 4. In an example, the first set of color fields may include R1 608, G1 608, and B 614. In an example, the second set of color fields may be the color fields 506. In an example, 912 may be performed by the dynamic field switcher 198.

At 914, the apparatus (e.g., a graphics processor) outputs an indication of the rendered first set of color fields or the rendered second set of color fields. For example, FIG. 7 at 716 shows that the graphics processor 702 may output an indication of the rendered first set of color fields or the rendered second set of color fields. In an example, the indication may be output to a DPU (e.g., the DPU 704, the DPU 521, etc.). In an example, 914 may be performed by the dynamic field switcher 198.

In one aspect, the first set of color fields may include a first red (R1) color field, a first green (G1) color field, and a blue (B) color field, and the second set of color fields may include the R1 color field, the G1 color field, the B color field, a second red (R2) color field, and a second green (G2) color field. For example, the first set of color fields may include R1 606, G1 608, and B 614 and the second set of color fields may be the color fields 506.

In one aspect, the first pose and the second pose may be associated with a wearable extended reality (XR) device worn on a head of a user. For example, the first pose and the second pose may be the render pose 404 and the display pose 406, respectively. Furthermore, FIG. 4 shows that the XR device 403 may be worn on a head of a user.

In one aspect, at 902, the apparatus (e.g., a graphics processor) may obtain, from a companion device, a second indication of a set of generated color fields associated with the companion device, where rendering the first set of color fields or the second set of color fields for the frame may include rendering the first set of color fields or the second set of color fields for the frame further based on the second indication of the set of generated color fields. For example, FIG. 7 at 706 shows that the graphics processor 702 may obtain, from a companion device, a second indication of a set of generated color fields associated with the companion device, where rendering the first set of color fields or the second set of color fields for the frame may include rendering the first set of color fields or the second set of color fields for the frame further based on the second indication of the set of generated color fields. In an example, the companion device may be the companion device 405. In an example, the set of generated color fields may include an R field, a G field, and a B field generated by the companion device 405 for each pixel in the frame. In an example, 902 may be performed by the dynamic field switcher 198.

In one aspect, at 904, the apparatus (e.g., a graphics processor) may compute a set of motion vectors associated with the second pose, where rendering the first set of color fields or the second set of color fields may include rendering the first set of color fields or the second set of color fields further based on the set of motion vectors. For example, FIG. 7 at 710 shows that the graphics processor 702 may compute a set of motion vectors associated with the second pose, where rendering the first set of color fields or the second set of color fields may include rendering the first set of color fields or the second set of color fields further based on the set of motion vectors. In an example, the set of motion vectors may be associated with the MV grid 524. In an example, 904 may be performed by the dynamic field switcher 198.

In one aspect, the set of motion vectors may correspond to the first set of color fields or the second set of color fields. For example, the set of motion vectors may be associated with R1 606, G1 608, and B 614 or the set of motion vectors may be associated with the color fields 506.

In one aspect, rendering the first set of color fields or the second set of color fields for the frame may further include performing a late stage reprojection on the frame based on the set of motion vectors. For example, rendering the first set of color fields or the second set of color fields for the frame at 714 may further include performing a late stage reprojection on the frame based on the set of motion vectors. The LSR may be associated with the LSR frame buffer 530, the video frame for LSR 532, and/or the depth map for LSR 534.

In one aspect, at 908, the apparatus (e.g., a graphics processor) may determine whether the computed difference is less than or equal to the threshold, where rendering the first set of color fields or the second set of color fields may include rendering the first set of color fields or the second set of color fields based on the determination. For example, FIG. 7 at 712 shows that the graphics processor 702 may determine whether the computed difference is less than or equal to the threshold, where rendering the first set of color fields or the second set of color fields at 714 may include rendering the first set of color fields or the second set of color fields based on the determination. In an example, the aforementioned aspect may correspond to 402 in FIG. 4. In an example, 908 may be performed by the dynamic field switcher 198.

In one aspect, the computed difference may be less than or equal to the threshold, and rendering the first set of color fields or the second set of color fields may include rendering the first set of color fields. For example, the aforementioned aspect may correspond to 410 in FIG. 4.

In one aspect, rendering the first set of color fields may include rendering the first set of color fields and storing the first set of color fields in a cache, where the cache may store a prior set of color fields corresponds to a second frame that is prior to the frame. In an example, the cache may be the LLC 504. In an example, the prior set of color fields may be R2 610 and G2 612.

In one aspect, the computed difference may be greater than the threshold, and rendering the first set of color fields or the second set of color fields may include rendering the second set of color fields. For example, the aforementioned aspect may correspond to 408 in FIG. 4.

In one aspect, outputting the indication of the rendered first set of color fields or the rendered second set of color fields may include transmitting the indication to a display processing unit (DPU). For example, FIG. 7 at 718 shows that outputting the indication of the rendered first set of color fields or the rendered second set of color fields may include transmitting the indication to the DPU 704.

In one aspect, outputting the indication of the rendered first set of color fields or the rendered second set of color fields may include storing the indication in memory, a cache, or a buffer. For example, outputting the indication of the rendered first set of color fields or the rendered second set of color fields at 716 may include storing the indication in memory, a cache, or a buffer. In an example, the cache may be the LLC 504.

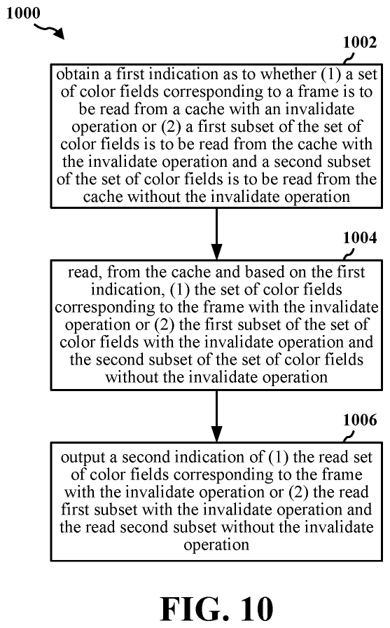

FIG. 10 is a flowchart 1000 of an example method of display processing in accordance with one or more techniques of this disclosure. The method may be performed by an apparatus, such as an apparatus for display processing, a DPU, such as the DPU 521 or the display processor 127 or other display processor, the device 104, the XR device 403, a wireless communication device, and the like, as used in connection with the aspects of FIGS. 1-7. In an example, the method may be associated with various advantages at a DPU, such as reduced computational burdens and reduced power consumption via dynamic color field switching. In an example, the method may be performed by the dynamic field switcher 199.

At 1002, the apparatus (e.g., a DPU) obtains a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation. For example, FIG. 7 at 720 shows that the DPU 704 may obtain a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation. In an example, the cache may be the LLC 504. In an example, the set of color fields may be the color fields 506. In another example, the set of color fields may be the color fields 604, the first subset may R2 610, G2 612, and B 614, and the second subset may be R1 606 and G1 608. In an example, 1002 may be performed by the dynamic field switcher 199.

At 1004, the apparatus (e.g., a DPU) reads, from the cache and based on the first indication, (1) the set of color fields corresponding to the frame with the invalidate operation or (2) the first subset of the set of color fields with the invalidate operation and the second subset of the set of color fields without the invalidate operation. For example, FIG. 7 at 722 shows that the DPU 704 may read, from the cache and based on the first indication, (1) the set of color fields corresponding to the frame with the invalidate operation or (2) the first subset of the set of color fields with the invalidate operation and the second subset of the set of color fields without the invalidate operation. In an example, reading with the invalidate operation may correspond to the read with invalidate operation 522 or the read with invalidate operation 618. In an example, reading without the invalidate operation may correspond to the read without invalidate operation 616. In an example, 1004 may be performed by the dynamic field switcher 199.

At 1006, the apparatus (e.g., a DPU) outputs a second indication of (1) the read set of color fields corresponding to the frame with the invalidate operation or (2) the read first subset with the invalidate operation and the read second subset without the invalidate operation. For example, FIG. 7 at 724 shows that the DPU 704 may output a second indication of (1) the read set of color fields corresponding to the frame with the invalidate operation or (2) the read first subset with the invalidate operation and the read second subset without the invalidate operation. In an example, 1006 may be performed by the dynamic field switcher 199.

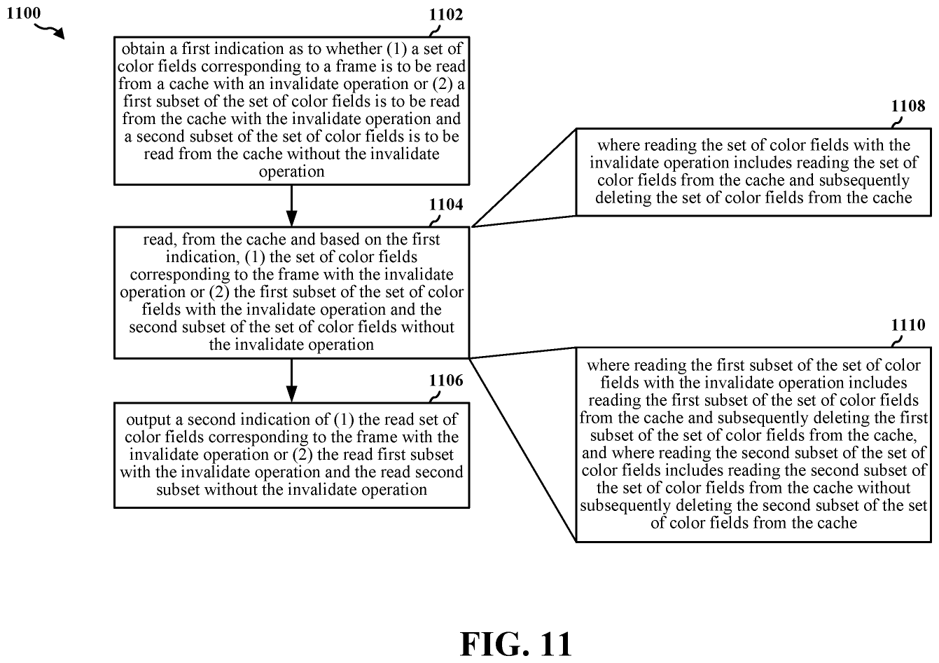

FIG. 11 is a flowchart 1100 of an example method of display processing in accordance with one or more techniques of this disclosure. The method may be performed by an apparatus, such as an apparatus for display processing, a DPU, such as the DPU 521 or the display processor 127 or other display processor, the device 104, the XR device 403, a wireless communication device, and the like, as used in connection with the aspects of FIGS. 1-7. In an example, the method may be associated with various advantages at a DPU, such as reduced computational burdens and reduced power consumption via dynamic color field switching. In an example, the method (including the various aspects detailed below) may be performed by the dynamic field switcher 199.

At 1102, the apparatus (e.g., a DPU) obtains a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation. For example, FIG. 7 at 720 shows that the DPU 704 may obtain a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation. In an example, the cache may be the LLC 504. In an example, the set of color fields may be the color fields 506. In another example, the set of color fields may be the color fields 604, the first subset may R2 610, G2 612, and B 614, and the second subset may be R1 606 and G1 608. In an example, 1102 may be performed by the dynamic field switcher 199.

At 1104, the apparatus (e.g., a DPU) reads, from the cache and based on the first indication, (1) the set of color fields corresponding to the frame with the invalidate operation or (2) the first subset of the set of color fields with the invalidate operation and the second subset of the set of color fields without the invalidate operation. For example, FIG. 7 at 722 shows that the DPU 704 may read, from the cache and based on the first indication, (1) the set of color fields corresponding to the frame with the invalidate operation or (2) the first subset of the set of color fields with the invalidate operation and the second subset of the set of color fields without the invalidate operation. In an example, reading with the invalidate operation may correspond to the read with invalidate operation 522 or the read with invalidate operation 618. In an example, reading without the invalidate operation may correspond to the read without invalidate operation 616. In an example, 1104 may be performed by the dynamic field switcher 199.

At 1106, the apparatus (e.g., a DPU) outputs a second indication of (1) the read set of color fields corresponding to the frame with the invalidate operation or (2) the read first subset with the invalidate operation and the read second subset without the invalidate operation. For example, FIG. 7 at 724 shows that the DPU 704 may output a second indication of (1) the read set of color fields corresponding to the frame with the invalidate operation or (2) the read first subset with the invalidate operation and the read second subset without the invalidate operation. In an example, 1106 may be performed by the dynamic field switcher 199.

In one aspect, the set of color fields may include a first red (R1) color field, a first green (G1) color field, a blue (B) color field, a second red (R2) color field, and a second green (G2) color field, where the first subset may include the R2 color field, the G2 color field, and the B color field, and where the second subset may include the R1 color field and the G1 color field. For example, the set of color fields may be the color fields 506. In an example, the first subset may include R2 610, G2 612, and B 614 and the second subset may include R1 606 and G1 608.

In one aspect, at 1108, reading the set of color fields with the invalidate operation may include reading the set of color fields from the cache and subsequently deleting the set of color fields from the cache. For example, reading the set of color fields with the invalidate operation at 722 may include reading the set of color fields from the cache and subsequently deleting the set of color fields from the cache. In an example, 1108 may be performed by the dynamic field switcher 199.

In one aspect, at 1110, reading the first subset of the set of color fields with the invalidate operation may include reading the first subset of the set of color fields from the cache and subsequently deleting the first subset of the set of color fields from the cache, and reading the second subset of the set of color fields may include reading the second subset of the set of color fields from the cache without subsequently deleting the second subset of the set of color fields from the cache. For example, reading the first subset of the set of color fields with the invalidate operation at 722 may include reading the first subset of the set of color fields from the cache and subsequently deleting the first subset of the set of color fields from the cache, and reading the second subset of the set of color fields at 722 may include reading the second subset of the set of color fields from the cache without subsequently deleting the second subset of the set of color fields from the cache. In an example, 1110 may be performed by the dynamic field switcher 199.

In one aspect, obtaining the first indication may include receiving the first indication from a graphics processor. For example, FIG. 7 shows that the DPU 704 may obtain the first indication from the graphics processor 702.

In one aspect, outputting the second indication may include transmitting, for display on a display panel, the second indication of (1) the read set of color fields or (2) the read first subset of color fields and the read second subset of color fields. For example, outputting the second indication at 724 may include transmitting, for display on a display panel, the second indication of (1) the read set of color fields or (2) the read first subset of color fields and the read second subset of color fields. In an example, the display panel may be or include the display(s) 131.

In one aspect, outputting the second indication may include storing, in memory or a buffer, the second indication of (1) the read set of color fields or (2) the read first subset of color fields and the read second subset of color fields. For example, outputting the second indication at 724 may include storing, in memory or a buffer, the second indication of (1) the read set of color fields or (2) the read first subset of color fields and the read second subset of color fields.

In one aspect, the second subset of the set of color fields may correspond to a second frame that is prior to the frame. For example, R1 606 and G1 608 may correspond to a second frame that is prior to the frame.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for computing a difference between (1) a first pose corresponding to a rendering time instance for a frame and (2) a second pose corresponding to a display time instance for the frame that occurs after the rendering time instance. The apparatus may further include means for rendering a first set of color fields or a second set of color fields for the frame based on the computed difference and a threshold, where the first set of color fields and the second set of color fields include a first number of color fields and a second number of color fields, respectively, where the first number of color fields is less than the second number of color fields. The apparatus may further include means for outputting an indication of the rendered first set of color fields or the rendered second set of color fields. The apparatus may further include means for obtaining, from a companion device, a second indication of a set of generated color fields associated with the companion device, where rendering the first set of color fields or the second set of color fields for the frame includes rendering the first set of color fields or the second set of color fields for the frame further based on the second indication of the set of generated color fields. The apparatus may further include means for computing a set of motion vectors associated with the second pose, where rendering the first set of color fields or the second set of color fields includes rendering the first set of color fields or the second set of color fields further based on the set of motion vectors. The apparatus may further include means for determining whether the computed difference is less than or equal to the threshold, where rendering the first set of color fields or the second set of color fields includes rendering the first set of color fields or the second set of color fields based on the determination.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus may include means for obtaining a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation. The apparatus may further include means for reading, from the cache and based on the first indication. (1) the set of color fields corresponding to the frame with the invalidate operation or (2) the first subset of the set of color fields with the invalidate operation and the second subset of the set of color fields without the invalidate operation. The apparatus may further include means for outputting a second indication of (1) the read set of color fields corresponding to the frame with the invalidate operation or (2) the read first subset with the invalidate operation and the read second subset without the invalidate operation.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C. B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, including: computing a difference between (1) a first pose corresponding to a rendering time instance for a frame and (2) a second pose corresponding to a display time instance for the frame that occurs after the rendering time instance; rendering a first set of color fields or a second set of color fields for the frame based on the computed difference and a threshold, wherein the first set of color fields and the second set of color fields include a first number of color fields and a second number of color fields, respectively, wherein the first number of color fields is less than the second number of color fields; and outputting an indication of the rendered first set of color fields or the rendered second set of color fields.

Aspect 2 may be combined with aspect 1, wherein the first set of color fields includes a first red (R1) color field, a first green (G1) color field, and a blue (B) color field, and wherein the second set of color fields includes the R1 color field, the G1 color field, the B color field, a second red (R2) color field, and a second green (G2) color field.

Aspect 3 may be combined with any of aspects 1-2, wherein the first pose and the second pose are associated with a wearable extended reality (XR) device worn on a head of a user.

Aspect 4 may be combined with aspect 3, further including: obtaining, from a companion device, a second indication of a set of generated color fields associated with the companion device, wherein rendering the first set of color fields or the second set of color fields for the frame includes rendering the first set of color fields or the second set of color fields for the frame further based on the second indication of the set of generated color fields.

Aspect 5 may be combined with aspect 4, further including: computing a set of motion vectors associated with the second pose, wherein rendering the first set of color fields or the second set of color fields includes rendering the first set of color fields or the second set of color fields further based on the set of motion vectors.

Aspect 6 may be combined with aspect 5, wherein the set of motion vectors corresponds to the first set of color fields or the second set of color fields.

Aspect 7 may be combined with any of aspects 5-6, wherein rendering the first set of color fields or the second set of color fields for the frame further includes performing a late stage reprojection on the frame based on the set of motion vectors.

Aspect 8 may be combined with any of aspects 1-7, further including: determining whether the computed difference is less than or equal to the threshold, wherein rendering the first set of color fields or the second set of color fields includes rendering the first set of color fields or the second set of color fields based on the determination.

Aspect 9 may be combined with aspect 8, wherein the computed difference is less than or equal to the threshold, and wherein rendering the first set of color fields or the second set of color fields includes rendering the first set of color fields.

Aspect 10 may be combined with aspect 9, wherein rendering the first set of color fields includes rendering the first set of color fields and storing the first set of color fields in a cache, wherein the cache stores a prior set of color fields corresponds to a second frame that is prior to the frame.

Aspect 11 may be combined with aspect 8, wherein the computed difference is greater than the threshold, and wherein rendering the first set of color fields or the second set of color fields includes rendering the second set of color fields.

Aspect 12 may be combined with any of aspects 1-11, wherein outputting the indication of the rendered first set of color fields or the rendered second set of color fields includes transmitting the indication to a display processing unit (DPU).

Aspect 13 may be combined with any of aspects 1-12, wherein outputting the indication of the rendered first set of color fields or the rendered second set of color fields includes storing the indication in memory, a cache, or a buffer.

Aspect 14 is an apparatus for graphics processing comprising a processor coupled to a memory and, based on information stored in the memory, the processor is configured to implement a method as in any of aspects 1-13.

Aspect 15 may be combined with aspect 14 and comprises that the apparatus is a wireless communication device comprising at least one of a transceiver or an antenna coupled to the processor, wherein to obtain the second indication, the processor is configured to obtain the second indication via at least one of the transceiver or the antenna.

Aspect 16 is an apparatus for graphics processing comprising means for implementing a method as in any of aspects 1-13.

Aspect 17 is a computer-readable medium (e.g., a non-transitory computer readable-medium) storing computer executable code, the computer executable code, when executed by a processor, causes the processor to implement a method as in any of aspects 1-13.

Aspect 18 is a method of display processing, including: obtaining a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation; reading, from the cache and based on the first indication, (1) the set of color fields corresponding to the frame with the invalidate operation or (2) the first subset of the set of color fields with the invalidate operation and the second subset of the set of color fields without the invalidate operation; and outputting a second indication of (1) the read set of color fields corresponding to the frame with the invalidate operation or (2) the read first subset with the invalidate operation and the read second subset without the invalidate operation.

Aspect 19 may be combined with aspect 18, wherein the set of color fields includes a first red (R1) color field, a first green (G1) color field, a blue (B) color field, a second red (R2) color field, and a second green (G2) color field, wherein the first subset includes the R2 color field, the G2 color field, and the B color field, and wherein the second subset includes the R1 color field and the G1 color field.

Aspect 20 may be combined with any of aspects 18-19, wherein reading the set of color fields with the invalidate operation includes reading the set of color fields from the cache and subsequently deleting the set of color fields from the cache.

Aspect 21 may be combined with any of aspects 18-20, wherein reading the first subset of the set of color fields with the invalidate operation includes reading the first subset of the set of color fields from the cache and subsequently deleting the first subset of the set of color fields from the cache, and wherein reading the second subset of the set of color fields includes reading the second subset of the set of color fields from the cache without subsequently deleting the second subset of the set of color fields from the cache.

Aspect 22 may be combined with any of aspects 18-21, wherein obtaining the first indication includes receiving the first indication from a graphics processor.

Aspect 23 may be combined with any of aspects 18-22, wherein outputting the second indication includes transmitting, for display on a display panel, the second indication of (1) the read set of color fields or (2) the read first subset of color fields and the read second subset of color fields.

Aspect 24 may be combined with any of aspects 18-23, wherein outputting the second indication includes storing, in memory or a buffer, the second indication of (1) the read set of color fields or (2) the read first subset of color fields and the read second subset of color fields.

Aspect 25 may be combined with any of aspects 18-24, wherein the second subset of the set of color fields corresponds to a second frame that is prior to the frame.

Aspect 26 is an apparatus for display processing comprising a processor coupled to a memory and, based on information stored in the memory, the processor is configured to implement a method as in any of aspects 18-25.

Aspect 27 may be combined with aspect 26 and comprises that the apparatus is a wireless communication device.

Aspect 28 is an apparatus for display processing comprising means for implementing a method as in any of aspects 18-25.

Aspect 29 is a computer-readable medium (e.g., a non-transitory computer readable-medium) storing computer executable code, the computer executable code, when executed by a processor, causes the processor to implement a method as in any of aspects 18-25.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
compute a difference between (1) a first pose corresponding to a rendering time instance for a frame and (2) a second pose corresponding to a display time instance for the frame that occurs after the rendering time instance;
render a first set of color fields or a second set of color fields for the frame based on the computed difference and a threshold, wherein the first set of color fields and the second set of color fields include a first number of color fields and a second number of color fields, respectively, wherein the first number of color fields is less than the second number of color fields; and
output an indication of the rendered first set of color fields or the rendered second set of color fields.

2. The apparatus of claim 1, wherein the first set of color fields comprises a first red (R1) color field, a first green (G1) color field, and a blue (B) color field, and wherein the second set of color fields comprises the R1 color field, the G1 color field, the B color field, a second red (R2) color field, and a second green (G2) color field.

3. The apparatus of claim 1, wherein the first pose and the second pose are associated with a wearable extended reality (XR) device worn on a head of a user.

4. The apparatus of claim 3, wherein the processor is further configured to:
obtain, from a companion device, a second indication of a set of generated color fields associated with the companion device, wherein to render the first set of color fields or the second set of color fields for the frame, the processor is configured to render the first set of color fields or the second set of color fields for the frame further based on the second indication of the set of generated color fields.

5. The apparatus of claim 4, wherein the apparatus is a wireless communication device comprising at least one of a transceiver or an antenna coupled to the processor, wherein to obtain the second indication, the processor is configured to obtain the second indication via at least one of the transceiver or the antenna.

6. The apparatus of claim 4, wherein the processor is further configured to:
compute a set of motion vectors associated with the second pose, wherein to render the first set of color fields or the second set of color fields, the processor is configured to render the first set of color fields or the second set of color fields further based on the set of motion vectors.

7. The apparatus of claim 6, wherein the set of motion vectors corresponds to the first set of color fields or the second set of color fields.

8. The apparatus of claim 6, wherein to render the first set of color fields or the second set of color fields for the frame further, the processor is configured to perform a late stage reprojection on the frame based on the set of motion vectors.

9. The apparatus of claim 1, wherein the processor is further configured to:
determine whether the computed difference is less than or equal to the threshold, wherein to render the first set of color fields or the second set of color fields, the processor is configured to render the first set of color fields or the second set of color fields based on the determination.

10. The apparatus of claim 9, wherein the computed difference is less than or equal to the threshold, and wherein to render the first set of color fields or the second set of color fields, the processor is configured to render the first set of color fields.

11. The apparatus of claim 10, wherein to render the first set of color fields, the processor is configured to render the first set of color fields and store the first set of color fields in a cache, wherein the cache stores a prior set of color fields corresponds to a second frame that is prior to the frame.

12. The apparatus of claim 9, wherein the computed difference is greater than the threshold, and wherein to render the first set of color fields or the second set of color fields, the processor is configured to render the second set of color fields.

13. The apparatus of claim 1, wherein to output the indication of the rendered first set of color fields or the rendered second set of color fields, the processor is configured to transmit the indication to a display processing unit (DPU).

14. The apparatus of claim 1, wherein to output the indication of the rendered first set of color fields or the rendered second set of color fields, the processor is configured to store the indication in the memory, a cache, or a buffer.

15. An apparatus for display processing, comprising:
a memory; and
a processor coupled to the memory and, based on information stored in the memory, the processor is configured to:
obtain a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation;
read, from the cache and based on the first indication, (1) the set of color fields corresponding to the frame with the invalidate operation or (2) the first subset of the set of color fields with the invalidate operation and the second subset of the set of color fields without the invalidate operation; and
output a second indication of (1) the read set of color fields corresponding to the frame with the invalidate operation or (2) the read first subset with the invalidate operation and the read second subset without the invalidate operation.

16. The apparatus of claim 15, wherein the set of color fields comprises a first red (R1) color field, a first green (G1) color field, a blue (B) color field, a second red (R2) color field, and a second green (G2) color field, wherein the first subset comprises the R2 color field, the G2 color field, and the B color field, and wherein the second subset comprises the R1 color field and the G1 color field.

17. The apparatus of claim 15, wherein to read the set of color fields with the invalidate operation, the processor is configured to read the set of color fields from the cache and subsequently delete the set of color fields from the cache.

18. The apparatus of claim 15, wherein to read the first subset of the set of color fields with the invalidate operation, the processor is configured to read the first subset of the set of color fields from the cache and subsequently delete the first subset of the set of color fields from the cache, and wherein to read the second subset of the set of color fields, the processor is configured to read the second subset of the set of color fields from the cache without a subsequent deletion of the second subset of the set of color fields from the cache.

19. The apparatus of claim 15, wherein to obtain the first indication, the processor is configured to receive the first indication from a graphics processor.

20. The apparatus of claim 15, wherein to output the second indication, the processor is configured to transmit, for display on a display panel, the second indication of (1) the read set of color fields or (2) the read first subset of color fields and the read second subset of color fields.

21. The apparatus of claim 15, wherein to output the second indication, the processor is configured to store, in the memory or a buffer, the second indication of (1) the read set of color fields or (2) the read first subset of color fields and the read second subset of color fields.

22. The apparatus of claim 15, wherein the second subset of the set of color fields corresponds to a second frame that is prior to the frame.

23. The apparatus of claim 15, wherein the apparatus is a wireless communication device comprising at least one of a transceiver or an antenna coupled to the processor.

24. A method of graphics processing, comprising:
computing a difference between (1) a first pose corresponding to a rendering time instance for a frame and (2) a second pose corresponding to a display time instance for the frame that occurs after the rendering time instance;
rendering a first set of color fields or a second set of color fields for the frame based on the computed difference and a threshold, wherein the first set of color fields and the second set of color fields include a first number of color fields and a second number of color fields, respectively, wherein the first number of color fields is less than the second number of color fields; and
outputting an indication of the rendered first set of color fields or the rendered second set of color fields.

25. The method of claim 24, wherein the first set of color fields comprises a first red (R1) color field, a first green (G1) color field, and a blue (B) color field, and wherein the second set of color fields comprises the R1 color field, the G1 color field, the B color field, a second red (R2) color field, and a second green (G2) color field.

26. The method of claim 24, wherein the first pose and the second pose are associated with a wearable extended reality (XR) device worn on a head of a user.

27. The method of claim 26, further comprising:
obtaining, from a companion device, a second indication of a set of generated color fields associated with the companion device, wherein rendering the first set of color fields or the second set of color fields for the frame comprises rendering the first set of color fields or the second set of color fields for the frame further based on the second indication of the set of generated color fields.

28. The method of claim 27, further comprising:
computing a set of motion vectors associated with the second pose, wherein rendering the first set of color fields or the second set of color fields comprises rendering the first set of color fields or the second set of color fields further based on the set of motion vectors.

29. The method of claim 28, wherein the set of motion vectors corresponds to the first set of color fields or the second set of color fields.

30. A method of display processing, comprising:
obtaining a first indication as to whether (1) a set of color fields corresponding to a frame is to be read from a cache with an invalidate operation or (2) a first subset of the set of color fields is to be read from the cache with the invalidate operation and a second subset of the set of color fields is to be read from the cache without the invalidate operation;
reading, from the cache and based on the first indication, (1) the set of color fields corresponding to the frame with the invalidate operation or (2) the first subset of the set of color fields with the invalidate operation and the second subset of the set of color fields without the invalidate operation; and
outputting a second indication of (1) the read set of color fields corresponding to the frame with the invalidate operation or (2) the read first subset with the invalidate operation and the read second subset without the invalidate operation.
